(19) United States
(12) Patent Application Publication
(10) Pub. No.: US 2006/0082808 A1
(43) Pub. Date: Apr. 20, 2006

(54) Method and system for printing electronic documents

(75) Inventor: Steve Borza, Ottawa (CA)

Correspondence Address: FREEDMAN & ASSOCIATES, 117 CENTREPOINTE DRIVE, SUITE 350, NEPEAN, ONTARIO, K2G 5X3, CA

(73) Assignee: Memory Experts International Inc., Montreal (CA)

(21) Appl. No.: 10/963,794

(22) Filed: Oct. 14, 2004

(51) Int. Cl. G06F 3/12

(52) U.S. Cl. 358/1.15

(57) ABSTRACT

A method and system for printing a document is disclosed. Accordingly, a secure portable storage medium is provided in electrical communication with the first workstation and electrically coupled thereto. A document in electronic form is then provided at the first workstation for printing thereof. The document is stored within a secure portable storage medium in communication with the first workstation, the secure portable storage medium requiring a user authorization event prior to supporting at least one of retrieving data therefrom and storing data therein. The secure portable storage medium is then coupled with a second station including a printer, the secure portable storage medium in electrical communication with the second station. The document is then retrieved from the secure portable storage medium and provided to the printer where it is printed.

### FIELD OF THE INVENTION

The invention relates to the field of printing and more particularly to the field of printing of secure documents.

### BACKGROUND OF THE INVENTION

Secure printing is a very complex field. There is a concern over data delivery from a workstation to a print server and concern over physical security of the printed document. For example, it is a simpler matter to wait by a printer and take a copy of a secure document once printed than to install software to violate network security and capture files being printed.

In order to secure printed documents, there are several known methods. The traditional method involves a person working with the printer to sort printed documents and to hand deliver those documents to the appropriate individuals. This is achieved by either placing documents into a secure mailbox, or by hand delivering the documents to the individuals upon request from an authorized individual. This traditional method is quite costly for small organizations and, unfortunately, the person working with the printer has access to all of the printed documents.

Another method is to provide each document via a network to the print server. There each print job is held until an authorized user authorized printing of the job. Once authorized, each job is printed while the authorized party looks on and ensures the security of their printed documents.

Unfortunately, when a print job is not available, it is unknown whether it was printed beforehand or is simply lost. As such, tracking of documents is difficult. Further, documents are, during transit, interceptable allowing for security flaws in the communication process to be exploited.

It would be advantageous to provide a method for securely printing documents that overcomes the limitations of the prior art.

### SUMMARY OF THE INVENTION

In accordance with the invention there is provided a method of printing a document comprising: providing a first workstation; providing a secure portable storage medium in electrical communication with the first workstation and electrically coupled thereto; providing a document in electronic form at the first workstation for printing thereof; storing the document within a secure portable storage medium in communication with the first workstation, the secure portable storage medium requiring a user authorization event prior to supporting at least one of retrieving data therefrom and storing data therein; coupling the secure portable storage medium with a second station including a printer, the secure portable storage medium in electrical communication with the second station; and, retrieving the document from the secure portable storage medium; providing the retrieved document to the printer; and, printing the document on the printer.

In accordance with another embodiment of the invention there is provided a method of printing a document comprising: providing a first workstation including a computer and a monitor; providing a portable storage medium in electrical communication with the first workstation and electrically coupled thereto. providing a document in electronic form at the first workstation for printing thereof; storing the document within a portable storage medium in communication with the first workstation; decoupling the portable storage medium from the first workstation; coupling the portable storage medium with a second station including a printer, the portable storage medium in electrical communication with the second station; and, retrieving the document from the portable storage medium; providing the retrieved document to the printer; and, printing the document on the printer.

In accordance with the invention there is provided a secure portable storage medium comprising: a port for coupling the secure portable storage medium to a mating port; a non-volatile memory storage; at least a transducer for receiving user authorization data; a processor for comparing the user authorization data to previously stored data to determine a user authorization result and for providing of second stored data to a printer for printing thereof in response to a user authorization result indicative of an authorized user of the secure portable storage medium.

### BRIEF DESCRIPTION OF THE DRAWINGS

Exemplary embodiments of the invention will now be described in conjunction with the following drawings, in which:

FIG. 1 illustrates a simplified diagram of a workstation including a printer;

FIG. 2 illustrates a simplified diagram of a workstation in communication with a print server via a communication network;

FIG. 3 illustrates a computer system and a printer for use with the present invention;

FIG. 4 illustrates a simplified flow diagram of an embodiment according to the invention;

FIG. 5 illustrates a computer system and a print server for use with the present invention;

FIG. 6 illustrates a simplified flow diagram of an embodiment according to the invention;

FIG. 7 illustrates a computer system including a portable storage medium having two communication ports;

FIG. 8 illustrates a simplified flow diagram of an embodiment according to the invention;

FIG. 9 illustrates a computer system including a portable storage medium having two communication ports;

FIG. 10 illustrates a simplified flow diagram of an embodiment according to the invention;

FIG. 11 illustrates a computer system and a printer for use with the present invention;

FIG. 12 illustrates a simplified flow diagram of an embodiment according to the invention;

FIG. 13 illustrates a computer system and a print server for use with the present invention;

FIG. 14 illustrates a simplified flow diagram of an embodiment according to the invention;

FIG. 15 illustrates a computer system and a printer for use with the present invention;

FIG. 16 illustrates a simplified flow diagram of an embodiment according to the invention;

FIG. 17 illustrates a computer system and a printer and a separate print server for use with the present invention;

FIG. 18 illustrates a simplified flow diagram of an embodiment according to the invention;

FIG. 19 illustrates a computer system and a print server for use with the present invention; and,

FIG. 20 illustrates a simplified flow diagram of an embodiment according to the invention.

### DETAILED DESCRIPTION THE INVENTION

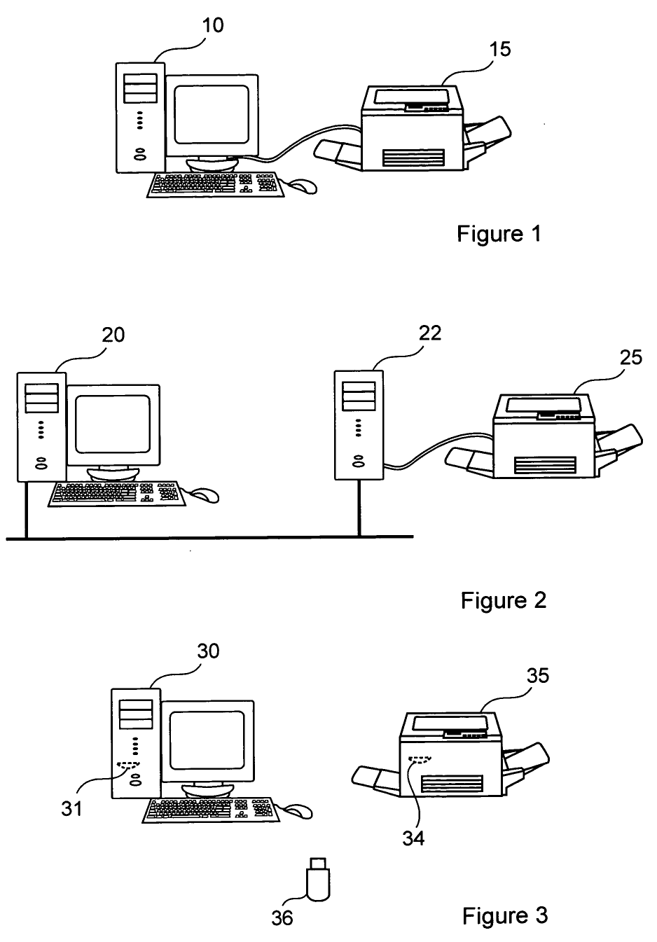

Referring to FIG. 1, a prior art workstation configuration is shown supporting printing of documents. A workstation 10 is shown in the form of a personal computer. The workstation 10 is used for generating and viewing a document using an application, for example a word processor. Once the document is in a final form or in a form for review, the document is provided to printer 15 for generating of a printed copy thereof—printing. In FIG. 1, the printer is shown directly coupled to the workstation. With the configuration of FIG. 1, a workstation setup provides a level of security for a printed document related to the physical security of the printer. When the printer is located within a secured office, any printed document is secured.

There has been a shift in the art of information technology from individual stand alone workstations to networks including networked servers, workstations, and printers all in communication one with another. Such a network architecture supports centralized management allowing for consistency, reliability and maintainability across an organization. Unfortunately, with such an architecture, security for printed documents is less assured.

Referring to FIG. 2, a simplified block diagram of a computer network is shown. A workstation 20 is in communication with a network print server 22. The network print server is in communication with a printer 25. The workstation 20 is used for generating and viewing a document using an application, for example a word processor. Once the document is in a final form or in a form for review, the document is provided to the printer server 22 for provision to the printer 25 for generating of a printed copy thereof—printing. Once printed, the printed document sits there awaiting being picked up by the user of the workstation. Sometimes, when printer utilization is low, the printed version is available immediately. Other times, there is a significant delay.

In order to secure documents printed in a network environment, some companies hire individuals to remove each printed document and to sort them in secure mailboxes. These mailboxes are either secured to prevent access by unauthorized users or are only accessible to the individuals for being provided to the users by hand. Either way, this prior art method is costly requiring an individual to sort and/or secure the printed documents manually.

Print to Insecure Storage Device and Couple Storage Device to Printer Directly

Referring to FIG. 3, a computer system is shown. Here, a computer 30 is shown having a removable storage medium 36 in the form of a portable storage medium 36. The portable storage medium is shown coupled to the computer via a standard interface port 31 in the form, for example, of a USB port. A printer 35 is shown having a USB port 34 for coupling with the portable storage medium 36.

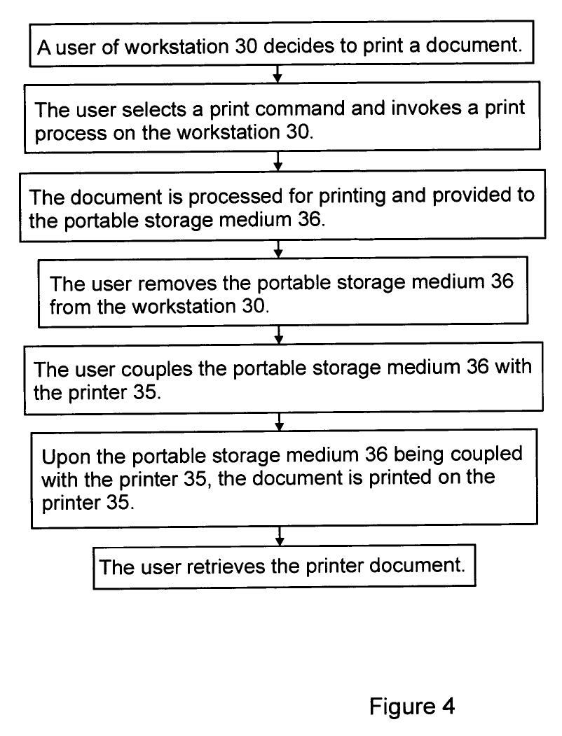

Referring to FIG. 4, a simplified flow diagram of a method of printing a document is shown. A user of workstation 30 decides to print a document. The user selects a print command and invokes a print process on the workstation 30. The document is processed for printing and provided to the portable storage medium 36. There the document is stored. At a later time, the user removes the portable storage medium 36 from the workstation 30 and couples the portable storage medium 36 with the printer 35. Upon the portable storage medium 36 being coupled with the printer 35, the document is printed on the printer 35. Thus, the user is present when the document is printed and, as such, can ensure the security of the printed document.

In the previous and subsequent figures, a portable storage medium is represented as a being connected to a computer via a standard interface port in the form of a USB port. Other forms are covered, such as Bluetooth, FireWire, infrared, SCSI, serial, etc. “Portable storage medium” includes passive devices such as JumpDrives, compact flash cards, secure digital cards, memory sticks, etc., as well as active storage devices such as PDA's (palm, pocket PC's), hand-held computers, mobile phones, etc.

Print to Storage Device and then Provide to Print Server

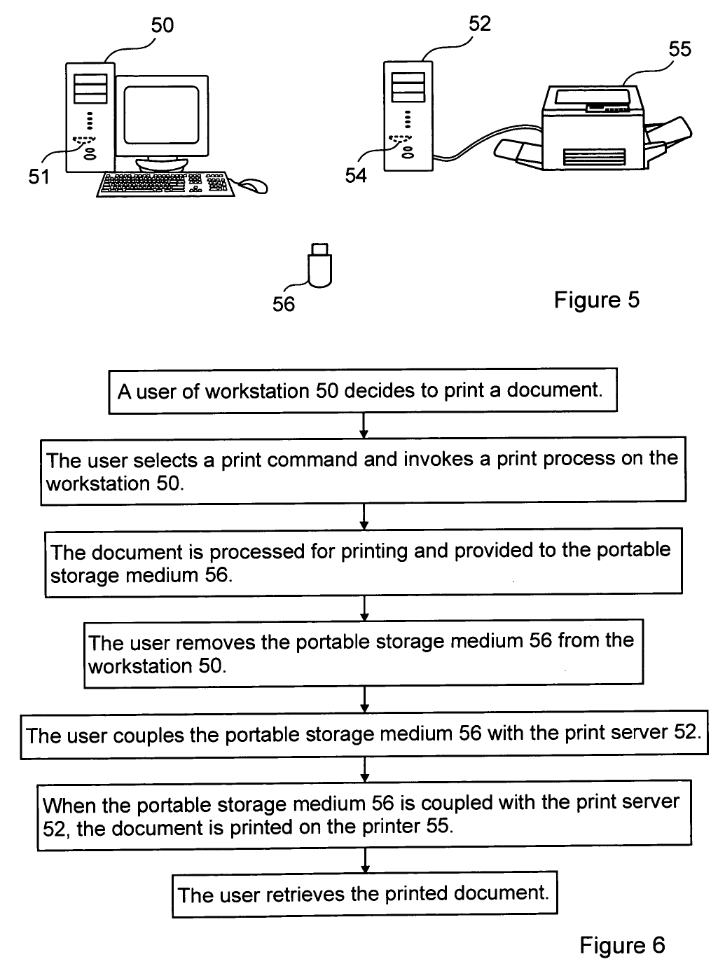

Referring to FIG. 5, a computer system is shown. Here, a computer 50 is shown having a removable storage medium 56 in the form of a portable storage medium. The portable storage medium is shown coupled to the computer 50 via a standard interface port 51 in the form, for example, of a USB port. A print server 52 is shown having a printer 55 coupled thereto. The print server 52 includes a standard port in the form of a USB port 54 for coupling with the portable storage medium 56.

Referring to FIG. 6, a simplified flow diagram of a method of printing a document is shown. A user of workstation 50 decides to print a document. The user selects a print command and invokes a print process on the workstation 50. The document is processed for printing and provided to the portable storage medium 56. There the document is stored. At a later time, the user removes the portable storage medium 56 from the workstation 50 and couples the portable storage medium 56 with the print server 52. When the portable storage medium 56 is coupled with the print server 52, the document is printed on the printer 55. Thus, the user is present when the document is printed and, as such, can ensure the security of the printed document.

Alternatively, in FIGS. 5 and 6, the portable storage medium could be coupled directly with the printer, instead of the print server, if the printer supports the appropriate standard interface port.

Print to Storage Device that has Second Coupling to Printer

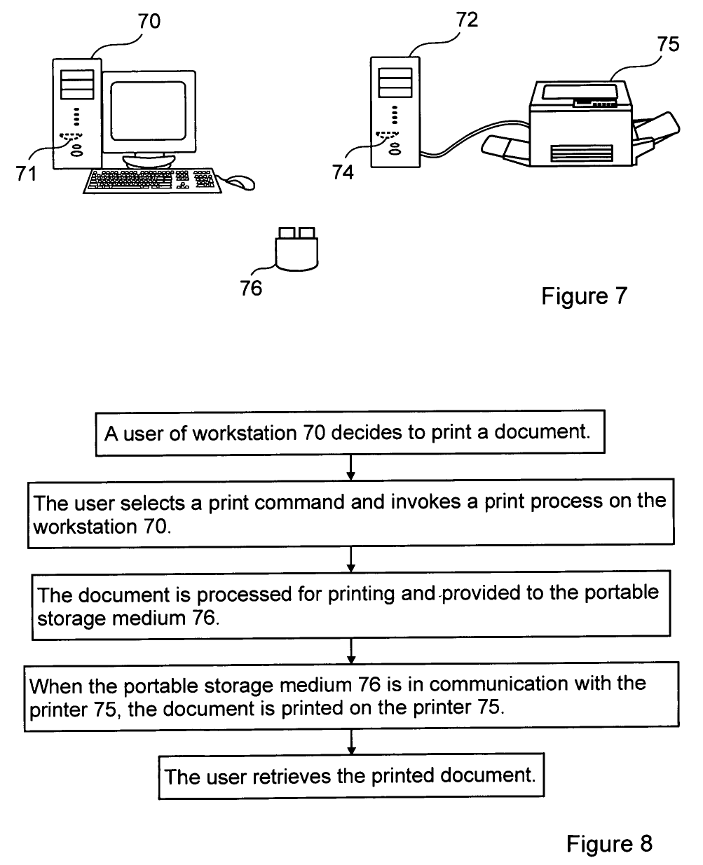

Referring to FIG. 7, a computer system is shown. Here, a computer 70 is shown having a removable storage medium 76 in the form of a portable storage medium. The portable storage medium is shown coupled to the computer 70 via a standard interface port 71 in the form, for example, of a USB port. The removable storage medium 76 includes a second port in the form, for example, of a second other USB port. A print server 72 is shown having a printer 75 coupled thereto. The print server 72 includes a standard port in the form of a USB port 74 for coupling with the second other USB port of the portable storage medium 76.

Referring to FIG. 8, a simplified flow diagram of a method of printing a document is shown. A user of workstation 70 decides to print a document. The user selects a print command and invokes a print process on the workstation 70. The document is processed for printing and provided to the portable storage medium 76. There the document is stored. When the portable storage medium 76 is in communication with the printer 75, the document is printed on the printer 75.

Optionally, the user is provided with options including the option to hold print jobs and release them at a later time. Also, the user is provided with the option of securing the printer for printing prior to releasing the documents and an ability to inform the user when the printer is available and when the job is complete.

Alternatively, in FIGS. 7 and 8, the portable storage medium could be coupled directly with the printer, instead of the print server, if the printer supports the appropriate standard interface port.

Print to Storage Device that has Second Coupling to Network Server

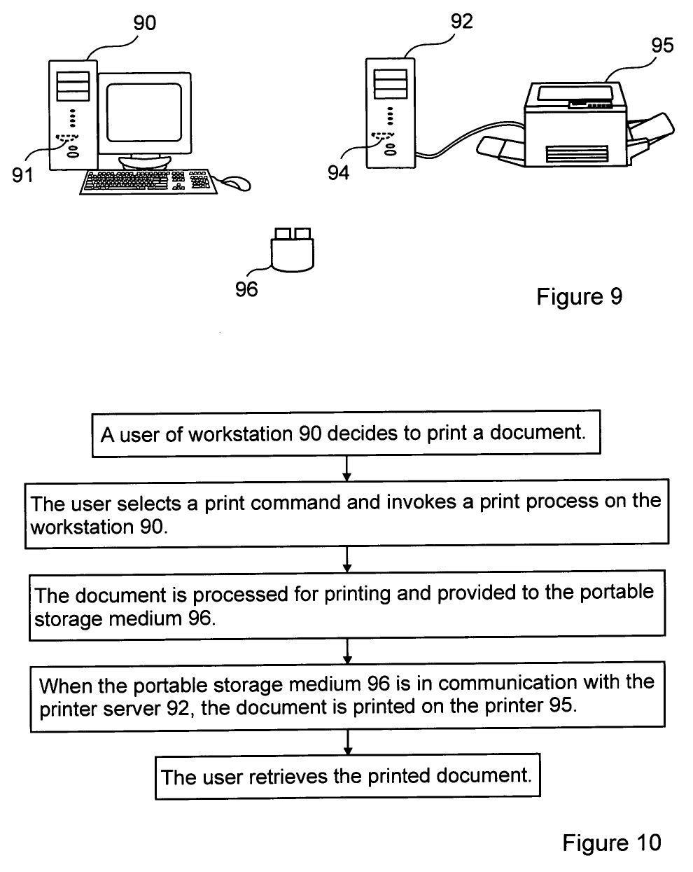

Referring to FIG. 9, a computer system is shown. Here, a computer 90 is shown having a removable storage medium 96 in the form of a portable storage medium. The portable storage medium is shown coupled to the computer 90 via a standard interface port 91 in the form, for example, of a USB port. The removable storage medium 96 includes a second port in the form of a second other USB port. The second other USB port is coupled to a print server 92 having a printer 95 coupled thereto.

Referring to FIG. 10, a simplified flow diagram of a method of printing a document is shown. A user of workstation 90 decides to print a document. The user selects a print command and invokes a print process on the workstation 90. The document is processed for printing and provided to the portable storage medium 96. There the document is stored. When the portable storage medium 96 is in communication with the print server 92, the document is printed on the printer 95.

Optionally, the user is provided with options including the option to hold print jobs and release them at a later time. Also, the user is provided with the option of securing the printer for printing prior to releasing the documents and an ability to inform the user when the printer is available and when the job is complete.

Print to Secure Storage Device, Couple with Printer, Authorize/Print

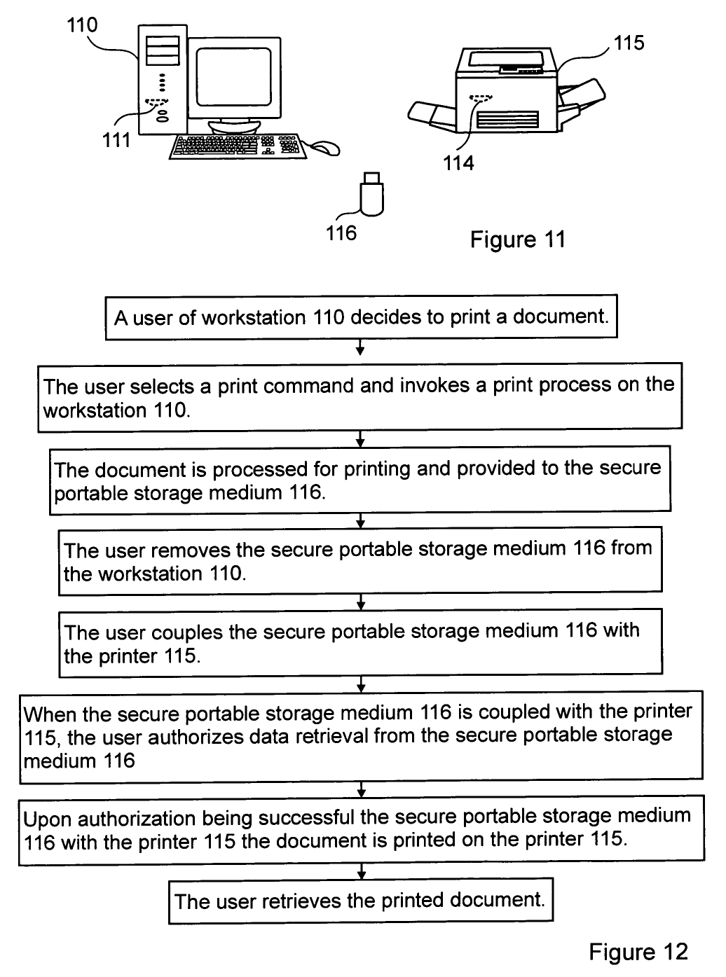

Referring to FIG. 11, a computer system is shown. Here, a computer 110 is shown having a removable storage medium 116 in the form of a secure portable storage medium 116. The secure portable storage medium is shown coupled to the computer via a standard interface port 111 in the form, for example, of a USB port. A printer 115 is shown having a USB port 114 for coupling with the secure portable storage medium 116.

Referring to FIG. 12, a simplified flow diagram of a method of printing a document is shown. A user of workstation 110 decides to print a document. The user selects a print command and invokes a print process on the workstation 110. The document is processed for printing and provided to the secure portable storage medium 116. There the document is stored. At a later time, the user removes the secure portable storage medium 116 from the workstation 110 and couples the secure portable storage medium 116 with the printer 115. When the secure portable storage medium 116 is coupled with the printer 115, the user authorizes data retrieval from the secure portable storage medium 116. Upon authorization being successful the secure portable storage medium 116 with the printer 115 the document is printed on the printer 115. Thus, the user is present when the document is printed and, as such, can ensure the security of the printed document.

Alternatively, the portable storage medium is other than a secure portable storage medium and security is managed through physically securing of the portable storage medium.

Authorization methods can include methods such as biometrics (e.g., thumbprint, voice, retinal scan), passwords, or ephemeral access codes; and can be enabled on either the portable storage medium (e.g., voice authorization on a mobile phone, entering a password on a PDA, or thumbprint check on passive device), or on the device with the standard interface port (e.g., typing a pass code on the printer's control pad)

Print to Secure Storage Device, Couple with Print Server, Authorize Print

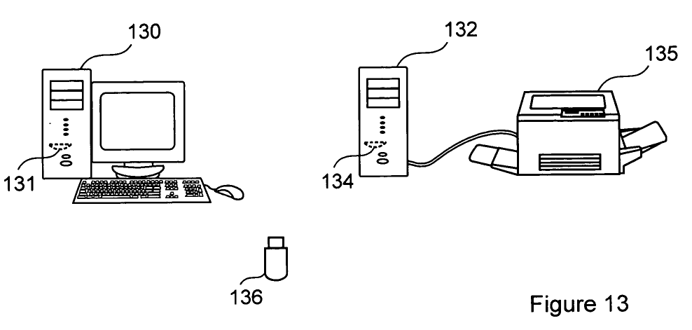

Referring to FIG. 13, a computer system is shown. Here, a computer 130 is shown having a removable storage medium 136 in the form of a secure portable storage medium. The secure portable storage medium is shown coupled to the computer 130 via a standard interface port 131 in the form, for example, of a USB port. A print server 132 is shown having a printer 135 coupled thereto. The print server 132 includes a standard port in the form of a USB port 134 for coupling with the secure portable storage medium 136.

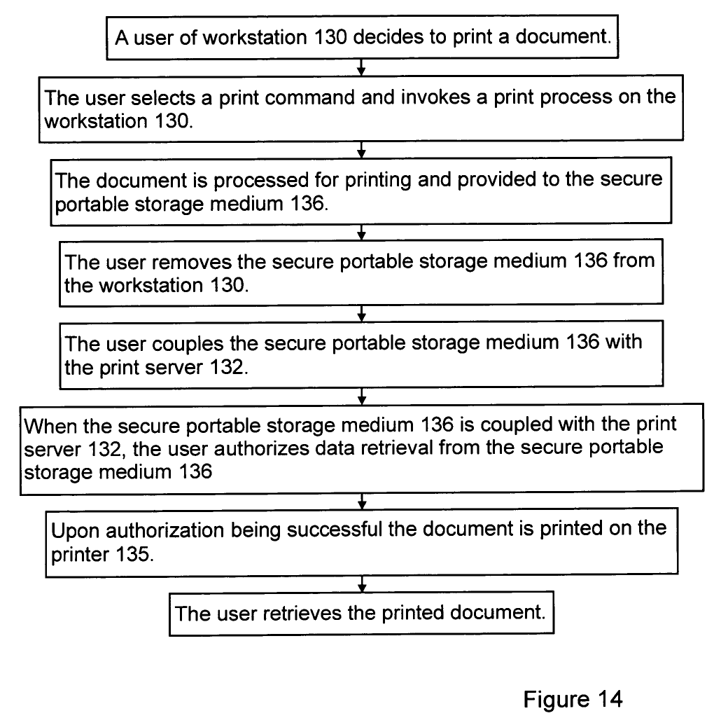

Referring to FIG. 14, a simplified flow diagram of a method of printing a document is shown. A user of workstation 130 decides to print a document. The user selects a print command and invokes a print process on the workstation 130. The document is processed for printing and provided to the secure portable storage medium 136. There the document is stored. At a later time, the user removes the secure portable storage medium 136 from the workstation 130 and couples the secure portable storage medium 136 with the print server 132. When the secure portable storage medium 136 is coupled with the print server 132, the user authorizes data retrieval from the secure portable storage medium 136. Upon authorization being successful the document is printed on the printer 135. Thus, the user is present when the document is printed and, as such, can ensure the security of the printed document.

Print to Secure Storage Device, Access and Modify Print Jobs

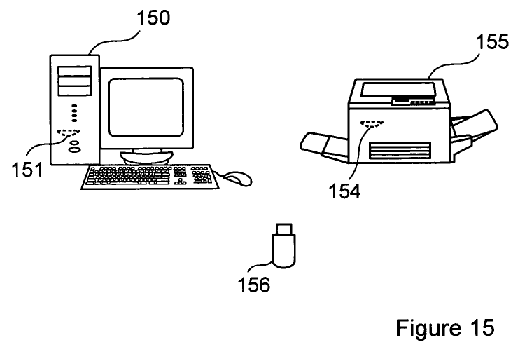

Referring to FIG. 15, a computer system is shown. Here, a computer 150 is shown having a removable storage medium 156 in the form of a secure portable storage medium 156. The secure portable storage medium is shown coupled to the computer via a standard interface port 151 in the form, for example, of a USB port. A printer 155 is shown having a USB port 154 for coupling with the secure portable storage medium 156.

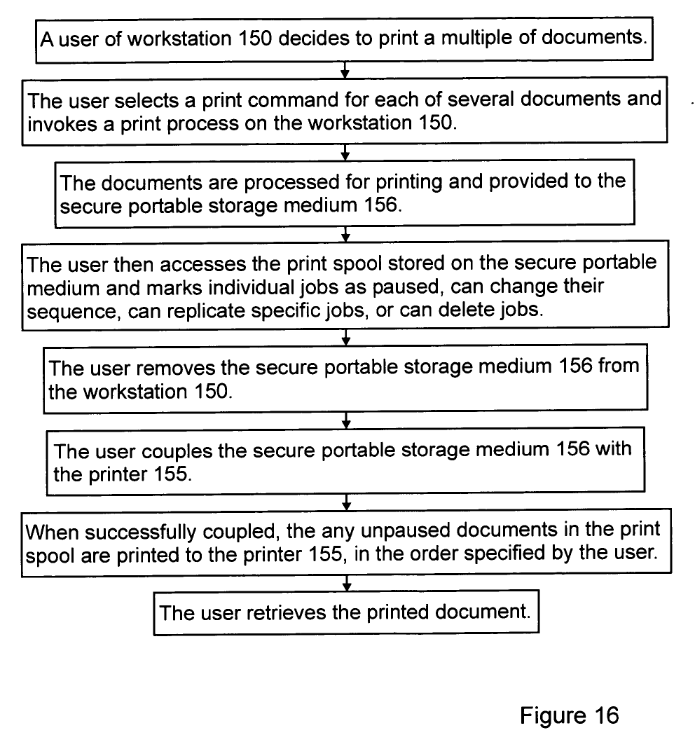

Referring to FIG. 16, a simplified flow diagram of a method of printing documents is shown. A user of workstation 150 decides to print a multitude of documents. The user selects a print command for each of several documents and invokes a print process on the workstation 150. The documents are processed for printing and provided to the secure portable storage medium 156. There the documents are stored. The user then accesses the print spool stored on the secure portable storage medium and can mark individual jobs as paused, to indicate that printing should occur not immediately; or can change their sequence, to allow particular jobs to print before or after other jobs, can replicate specific jobs, to allow them to be printed multiple times; or can delete jobs. At a later time, the user removes the secure portable storage medium 156 from the workstation 150 and couples the secure portable storage medium 156 with the printer 155. When successfully coupled, then any unpaused documents in the print spool are printed to the printer 155, in the order specified by the user.

Print to Secure Storage Device and Print a Number of Times

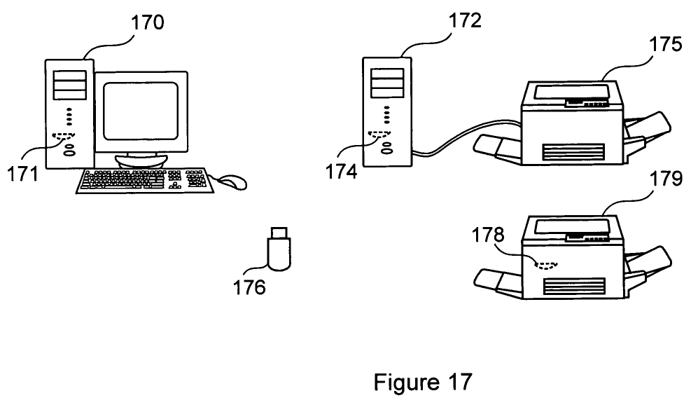

Referring to FIG. 17, a computer system is shown. Here, a computer 170 is shown having a removable storage medium 176 in the form of a secure portable storage medium 176. The secure portable storage medium is shown coupled to the computer via a standard interface port 171 in the form, for example, of a USB port. A printer 175 is shown having a USB port 174 for coupling with the secure portable storage medium 176. Additionally, there is a second other printer 179 with a USB port 178 for coupling with the secure portable storage medium 176.

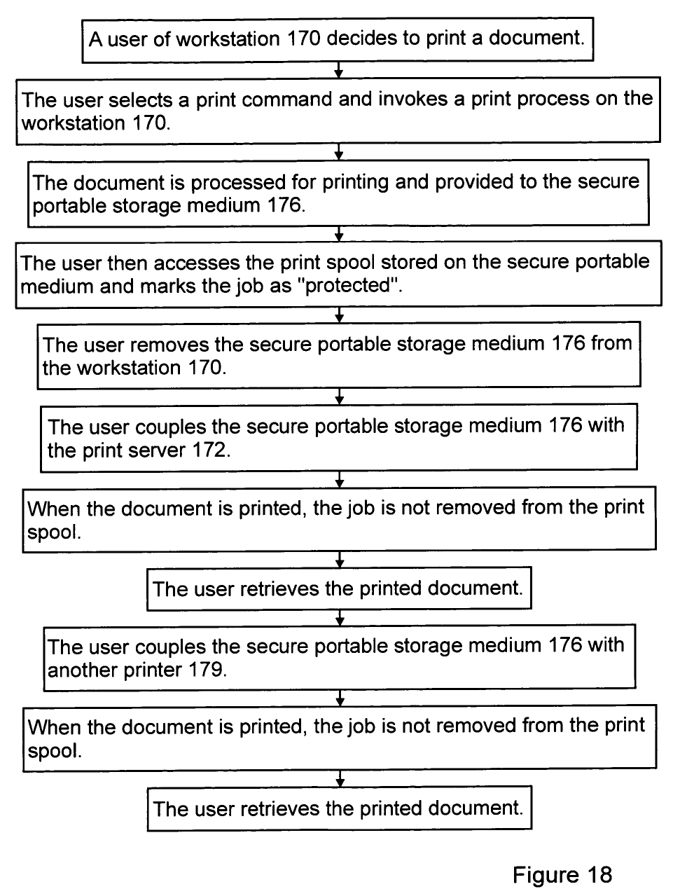

Referring to FIG. 18, a simplified flow diagram of a method of printing a document is shown. A user of workstation 170 decides to print a document. The user selects a print command and invokes a print process on the workstation 170. The document is processed for printing and provided to the secure portable storage medium 176. There the document is stored. The user then accesses the print spool stored on the secure portable storage medium and marks the job as “protected”. At a later time, the user removes the secure portable storage medium 176 from the workstation 170 and couples the secure portable storage medium 176 with the print server 172. When the document is printed, the job is not removed from the print spool. As a result the user can re-couple the secure portable storage medium 176 to the print server 172 at a later date to acquire another copy of the document, or alternatively, couple the secure portable storage medium 176 to another printer 179 to securely acquire a copy of the document at a second location.

Print to Secure (Secured by Recipient) Storage Device and Ship to Receiving End for Printing

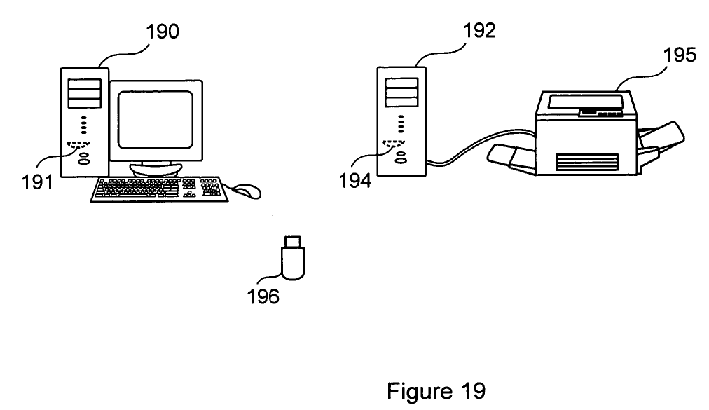

Referring to FIG. 19, a computer system is shown. Here, a computer 190 is shown having a removable storage medium 196 in the form of a secure portable storage medium. The secure portable storage medium is shown coupled to the computer 190 via a standard interface port 191 in the form, for example, of a USB port. A print server 192 is shown having a printer 195 coupled thereto. The print server 192 includes a standard port in the form of a USB port 194 for coupling with the secure portable storage medium 196.

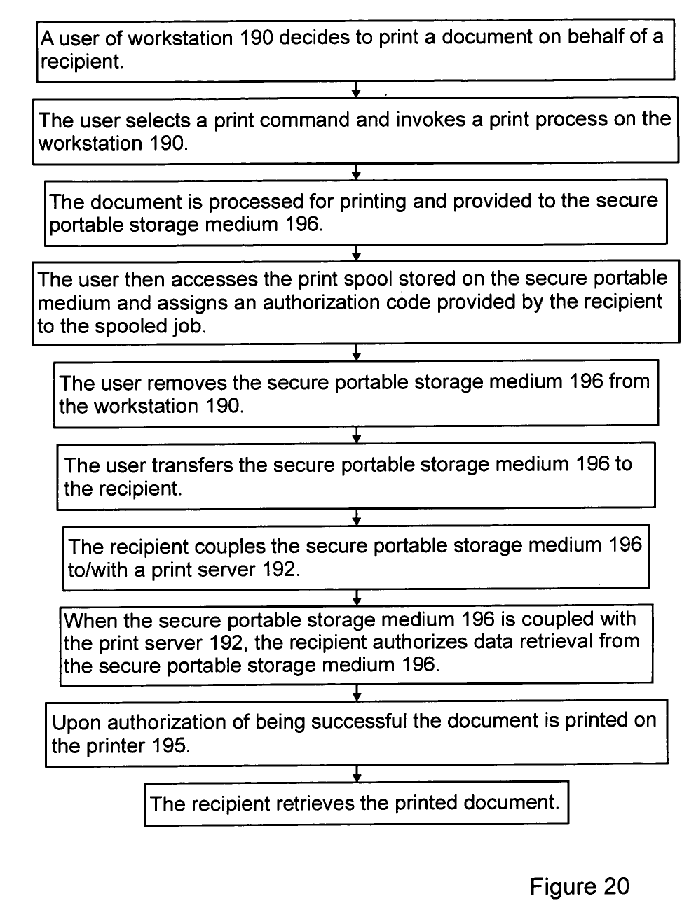

Referring to FIG. 20, a simplified flow diagram of a method of printing a document is shown. A user of workstation 190 decides to print a document on behalf of a recipient. The user selects a print command and invokes a print process on the workstation 190. The document is processed for printing and provided to the secure portable storage medium 196. There the document is stored. The user is then able to access the print spool stored on the secure portable storage medium and assign an authorization code provided by the recipient to the spooled job. At a later time, the user removes the secure portable storage medium 196 from the workstation 190 and transfers the secure portable storage medium 196 to the recipient whereupon the recipient couples the secure portable storage medium 196 to with a print server 192. When the secure portable storage medium 196 is coupled with the print server 192, the recipient authorizes data retrieval from the secure portable storage medium 196. Upon authorization being successful the document is printed on the printer 195. Thus, the recipient is present when the document is printed and, as such, can ensure the security of the printed document.

Some of the above embodiments are described with reference to secure portable storage media. Typically, the secure portable storage medium requires user authorization in order to access data stored therein and in order to store data therein. In some embodiments, the storage device requires user authorization to enable printing thereto. In other applications, printing to the storage medium is permitted absent user authorization but user authorization is required in order to print from the storage medium. In yet another embodiment, user authorization is required to print to the storage medium but not required in order to print the document. This latter embodiment is useful for storing of signature data within a document, wherein once printed by the authorized party to the storage medium any number of printed copies are permitted.

Numerous other embodiments may be envisaged without departing from the spirit or scope of the invention.

What is claimed is:

1. A method of printing a document comprising:
providing a first workstation;
providing a secure portable storage medium in electrical communication with the first workstation and electrically coupled thereto;
providing a document in electronic form at the first workstation for printing thereof;
storing the document within a secure portable storage medium in communication with the first workstation, the secure portable storage medium requiring a user authorization event prior to supporting at least one of retrieving data therefrom and storing data therein;
coupling the secure portable storage medium with a second station including a printer, the secure portable storage medium in electrical communication with the second station;
retrieving the document from the secure portable storage medium;
providing the retrieved document to the printer; and,
printing the document on the printer.

2. A method according to claim 1 wherein providing the document in electronic form is performed by executing a print command.

3. A method according to claim 2 wherein the steps of retrieving the document from the secure portable storage medium; and providing the retrieved document to the printer are performed absent execution of a same application from which the print command was issued.

4. A method according to claim 1 wherein the steps of retrieving the document from the secure portable storage medium; and providing the retrieved document to the printer are performed absent execution of a same application from which the document in electronic form was generated.

5. A method of printing a document comprising:
decoupling the secure portable storage medium from the first workstation prior to coupling the secure portable storage medium with the second station.

6. A method according to claim 5 wherein the secure portable storage medium comprises at least a transducer for receiving data from a user thereof, the data for use in authorizing a user thereof.

7. A method according to claim 6 wherein the at least a transducer includes a contact imager for imaging of a portion of a body in approximately contact therewith.

8. A method according to claim 6 wherein the secure portable storage medium is secured and wherein accessing data stored therein comprises:
providing authorization data to the portable storage medium via the at least a transducer;
comparing the authorization data to data relating to and authorized user of the secure portable storage medium to provide a comparison result; and,
when the comparison result is indicative of an authorized user, retrieving data stored within the secure portable storage medium.

9. A method according to claim 6 wherein the secure portable storage medium is secured and wherein accessing data stored therein comprises:
providing authorization data to the portable storage medium via the at least a transducer;
comparing the authorization data to data relating to an authorized user of the secure portable storage medium to provide a comparison result; and,
when the comparison result is indicative of an authorized user, storing data within the secure portable storage medium.

10. A method according to claim 6 wherein the secure portable storage medium is secured and wherein accessing data stored therein comprises:
providing authorization data to the portable storage medium via the at least a transducer;
comparing the authorization data to data relating to an authorized user of the secure portable storage medium to provide a comparison result; and,
when the comparison result is indicative of an authorized user, enabling the secure portable storage medium for retrieving data therefrom and for storing data therein.

11. A method according to claim 1 wherein the second station consists of a printer, the printer including a port for coupling with the portable storage medium.

12. A method according to claim 11 wherein the port is a USB port.

13. A method according to claim 11 wherein the portable storage medium includes data stored therein for, when executed, resulting in printing of a document stored therein by the printer.

14. A method according to claim 11 wherein the printer includes data stored therein for, when executed, resulting in printing of a document stored within the portable storage medium by the printer.

15. A method according to claim 1 wherein the second station comprises a second workstation and a printer, the second workstation including a port for coupling with the portable storage medium.

16. A method of printing a document comprising:
providing authorization data to the portable storage medium via the at least a transducer;
comparing the authorization data to data relating to an authorized user of the secure portable storage medium to provide a comparison result; and,
when the comparison result is indicative of an authorized user, providing data from the secure portable storage medium to the second station for printing thereof.

17. A method of printing a document comprising:
providing a first workstation including a computer and a monitor;
providing a portable storage medium in electrical communication with the first workstation and electrically coupled thereto.
providing a document in electronic form at the first workstation for printing thereof;
storing the document within a portable storage medium in communication with the first workstation;
decoupling the portable storage medium from the first workstation;
coupling the portable storage medium with a second station including a printer, the portable storage medium in electrical communication with the second station;
retrieving the document from the portable storage medium;
providing the retrieved document to the printer; and,
printing the document on the printer.

18. A method according to claim 17 comprising:
organizing documents stored within the portable storage medium at the first workstation while the portable storage medium is coupled thereto and wherein retrieving the document from the secure portable storage medium; providing the retrieved document to the printer; and, printing the document on the printer is performed automatically.

19. A secure portable storage medium comprising:
a port for coupling the secure portable storage medium to a mating port;
a non-volatile memory storage;
at least a transducer for receiving user authorization data;
a processor for comparing the user authorization data to previously stored data to determine a user authorization result and for providing of second stored data to a printer for printing thereof in response to a user authorization result indicative of an authorized user of the secure portable storage medium.

20. A secure portable storage medium according to claim 19 wherein the processor is for executing instructions for interfacing directly with a printer and for providing of second stored data to a printer in a form for printing thereof in response to a user authorization result indicative of an authorized user of the secure portable storage medium.

21. A secure portable storage medium according to claim 19 wherein the port is for electrically coupling the secure portable storage medium to a mating port.

22. A secure portable storage medium according to claim 21 comprising:
a second port for electrically coupling the secure portable storage medium to a mating port.

23. secure portable storage medium according to claim 19 comprising:
a contact imaging platen for imaging a surface of a user's body.

24. A secure portable storage medium according to claim 19 wherein the port is for wirelessly coupling the secure portable storage medium to another system, the wireless coupling operable over a short range.
